(19) United States
(12) Patent Application Publication
(10) Pub. No.: US 2005/0108549 A1
(43) Pub. Date: May 19, 2005

(54) Data processing apparatus and access limitation setting method for the same, and image processing system and control method for the same

(75) Inventor: Yasunori Kanai, Tokyo (JP)

Correspondence Address: Marc A. Rossi;ROSSI & ASSOCIATES, P.O. Box 826, Ashburn, VA, 20146-0826, US

(73) Assignee: CANON KABUSHIKI KAISHA, Tokyo (JP)

(21) Appl. No.: 10/987,479

(22) Filed: Nov. 12, 2004

(30) Foreign Application Priority Data
Nov. 14, 2003 (JP) 2003-385089

(51) Int. Cl. H04K 1/00

(52) U.S. Cl. 713/182

(57) ABSTRACT

A data processing apparatus can more easily set access limitation for an electronic document which has been read. The data processing apparatus is capable of storing image data of a document in one of a plurality of storage devices for which respective methods for restricting access stored data are different. An operating section 105 displays a screen for designating a type of access limitation for the image data. An access limitation for the image data corresponding to the type of access limitation designated with the screen is set according to the method for the storage device which stores the image data.

### CROSS REFERENCE TO RELATED APPLICATION

This application claims priority from Japanese Patent Application No. 2003-385089 filed Nov. 14, 2003, which is hereby incorporated by reference herein.

### BACKGROUND OF THE INVENTION

1. Field of the Invention

The present invention relates to a data processing apparatus and an access limitation setting method for the same, and an image processing system and a control method for the same, and more particularly, to a data processing apparatus in which different contents of access limitation can be applied in accessing image data of documents read and stored in respective different storage devices, and an access limitation setting method for the same, and an image processing system which can transmit image data of a document which has been read to a server on a network for storage, and a control method for the same.

2. Description of the Related Art

In recent years, due to the improvement of the image reading function and the image data transmission function of image processing apparatuses such as MFPs (Multi Function Printers), the proportion of documents which are distributed as electronic documents (in the form of electronic document data) has increased. For example, in the case of subsequent distribution of document data which has been used during a meeting to attendees at the meeting or to relevant personnel, there has been employed a method in which the document data is read by a MFP and converted into an electronic document, and then is uploaded to a FTP (File Transfer Protocol) server on a network (for example, refer to Japanese Patent Laid-Open Publication (Kokai) No. H11-134263). By doing this, it is possible for attendees at the meeting or relevant members of staff to access the FTP server on their own initiatives, and to read the document in electronic form.

On the other hand, the same results may be obtained even if the destination on which the electronic document is stored is not a FTP server, but is a so-called “box” storage device which is provided inside the MFP.

However, with the above described conventional method of distribution of a document, normally, no file access limitation process is performed at all with respect to the electronic document which is stored on the FTP server. Accordingly, while on the one hand a person who attended the meeting or the like is able freely to access the destination on which the electronic document is stored and to read that electronic document, on the other hand, it is possible for anyone at all to access and to read the electronic document, provided only that he knows the storage destination for the electronic document and, therefore, if a confidential document is to be stored and managed, it is necessary for the user to implement file access limitation for the electronic document explicitly and specially, and this imposes a burden upon the user.

### SUMMARY OF THE INVENTION

It is an object of the present invention to provide a data processing apparatus and an access limitation setting method for it, and an image processing system and a control method for it, which can more easily set access limitation for an electronic document which has been read.

To attain the above object, according to a first aspect of the present invention, there is provided a data processing apparatus which is capable of storing image data of a document in one of a plurality of storage devices for which respective methods for restricting access stored data are different, comprising a display device that displays a screen for designating a type of access limitation for the image data, and a setting device that sets an access limitation for the image data corresponding to the type of access limitation designated with the screen, according to the method for the storage device which stores the image data.

With this construction, a screen is displayed for designating a type of access limitation for image data, and an access limitation is set for the image data corresponding to the type of access limitation designated with the screen, according to the method for the storage device which stores the image data. As a result, it becomes easier to set the access limitation. For example, the user is not required to be aware of how to implement a method for restricting access data stored in each of a plurality of storage and therefore it is easy possible to set an appropriate access limitation by designating the type of access limitation.

Preferably, the setting device performs at least one process selected from the group consisting of transmitting a command which designates a subject who is permitted to perform at least one of reading and writing the image data, setting a password for the image data, and setting a password to a region in which the image data is stored, according to the method for the storage device which stores the image data.

Preferably, the setting device performs at least one process selected from the group consisting of changing a subject who is permitted to perform at least one of reading and writing the image data, selecting whether a password is to be set or not for the image data, selecting whether a password is to be set or not for the region in which the image data is stored, and changing the password set for the region, according to the type of access limitation designated with the screen.

Preferably, the display device displays at least one of a screen for designating the type of access limitation for the image data, a screen for designating one of the storage devices on which the image data is to be stored, and a screen for designating a password.

To attain the above object, according to a second aspect of the present invention, there is provided an image processing system comprising an image processing apparatus having a display section, a data processing apparatus connected to the image processing apparatus, and a server connected to the data processing apparatus, the image processing system being capable of storing image data of a document which has been read in the server, the data processing apparatus comprises a control command output device that outputs a control command for causing a predetermined screen to be displayed on the display section of the image processing apparatus, and an access limitation setting device that sets an access limitation for image data which is stored in the server, according to a type of access limitation which has been selected on the predetermined screen caused to be displayed by the control command.

With this construction, the data processing apparatus which is connected to the image processing apparatus sets an access limitation for the image data of a document that has been read by the image processing apparatus, according to a type of access limitation which has been selected on the predetermined screen caused to be displayed on the display section of the image processing apparatus. As a result, it become easier to impose an access limitation upon the image data of a document that has been read by the image processing apparatus, making it possible to reduce the load upon the user.

Preferably, the access limitation setting device is operable when the server is running on an operating system which is capable of setting access limitation for the image data on a file-by-file basis, to set access limitation by using a function of the operating system, and operable when the server is running on an operating system which is not capable of setting access limitation for the image data on a file-by-file basis, to set access limitation by using a password setting function provided by the server.

To attain the above object, according to a third aspect of the present invention, there is provided an image processing system comprising an image processing apparatus having a display section and being capable of storing image data of a document which has been read, and a data processing apparatus connected to the image processing apparatus, the data processing apparatus comprises a control command output device that outputs a control command for causing a predetermined screen to be displayed on the display section of the image processing apparatus, and an access limitation setting device that sets an access limitation for image data which is stored in the image processing apparatus, according to a type of access limitation which has been selected on the predetermined screen caused to be displayed by the control command.

Preferably, the image processing apparatus has a storage region in which the image data is stored, and the access limitation setting device is operable when no password is set for the storage region, to set a password for the storage region, and operable when a password is set for the storage region, to change the password which is set for the storage region.

To attain the above object, according to a fourth aspect of the present invention, there is provided an access limitation setting method for a data processing apparatus which is capable of storing image data of a document in one of a plurality of storage devices for which respective methods for restricting access stored data are different, comprising a display step of displaying a screen for designating a type of access limitation for the image data, and a setting step of setting an access limitation for the image data corresponding to the type of access limitation designated with screen, according to the method for the storage device which stores the image data.

Preferably, the setting step comprises performing at least one process selected from the group consisting of transmitting a command which designates a subject who is permitted to perform at least one of reading and writing the image data, setting a password for the image data, and setting a password to an region in which the image data is stored, according to the method for the storage device which stores the image data.

Preferably, the setting step comprises performing at least one process selected from the group consisting of changing a subject who is permitted to perform at least one of reading and writing the image data, selecting whether a password is to be set or not for the image data, selecting whether a password is to be set or not for the region in which the image data is stored, and changing the password set for the region, according to the type of access limitation designated with the screen.

Preferably, the display step comprises displaying at least one of a screen for designating the type of access limitation for the image data, a screen for designating one of the storage devices on which the image data is to be stored, and a screen for designating a password.

To attain the above object, according to a fifth aspect of the present invention, there is provided a control method for an image processing system comprising an image processing apparatus having a display section, a function expansion apparatus connected to the image processing apparatus, and a server connected to the data processing apparatus, the image processing system being capable of storing image data of a document which has been read in the server, comprising a control command output step of outputting a control command for causing a predetermined screen to be displayed on the display section of the image processing apparatus, to the server, and an access limitation setting step of setting an access limitation for image data which is stored in the server, according to a type of access limitation which has been selected on the predetermined screen caused to be displayed by the control command.

To attain the above object, according to a sixth aspect of the present invention, there is provided a control method for an image processing system comprising an image processing apparatus having a display section and being capable of storing image data of a document which has been read, and a data processing apparatus connected to the image processing apparatus, comprising a control command output step of causing the data processing apparatus to output a control command for causing a predetermined screen to be displayed on the display section of the image processing apparatus, to the image processing apparatus, and an access limitation setting step of setting an access limitation for image data which is stored in the image processing apparatus, according to a type of access limitation which has been selected on the predetermined screen caused to be displayed by the control command.

The above and other objects, features, and advantages of the invention will become more apparent from the following detailed description taken in conjunction with the accompanying drawings.

### BRIEF DESCRIPTION OF THE DRAWINGS

FIG. 1 is a diagram showing the overall arrangement of an image processing system according to a first embodiment of the present invention;

FIG. 2 is a block diagram schematically showing the hardware configuration of an expansion unit 102 for a MFP appearing in FIG. 1;

FIG. 3 is a block diagram schematically showing the hardware configuration of the MFP 101 appearing in FIG. 1;

FIG. 4 is a flow chart showing an access limitation process for image data which is executed by the image processing system of FIG. 1;

FIG. 5 is a diagram showing an example of a screen which is displayed on an operating section 105 during execution of the process of FIG. 4;

FIG. 6 is a flow chart showing a process A which is executed in a step S405 in FIG. 4;

FIG. 7 is a flow chart for a process B which is executed in a step S406 in FIG. 4;

FIG. 8 is a diagram showing an example of a screen which is displayed on the operating section 105 during execution of the process of FIG. 7;

FIG. 9 is a flow chart showing an access limitation process for image data which is executed by an image processing system according to a second embodiment of the present invention;

FIG. 10 is a diagram showing an example of a screen which is displayed on the operating section 105 during execution of the process of FIG. 9;

FIG. 11 is a flow chart showing a process C which is executed in a step S708 in FIG. 9;

FIG. 12 is a diagram showing an example of a screen which is displayed on the operating section 105 during execution of the process of FIG. 11; and

FIG. 13 is a diagram showing an example of another screen which is displayed on the operating section 105 during execution of the process of FIG. 11.

### DETAILED DESCRIPTION OF THE PREFERRED EMBODIMENTS

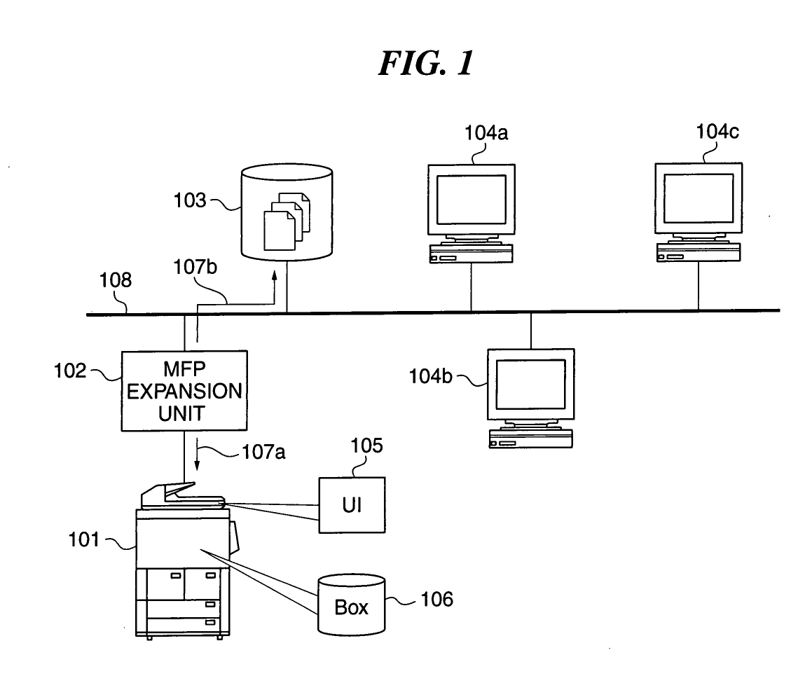

The present invention will now be described with reference to the drawings showing preferred embodiments thereof. FIG. 1 is a diagram showing the overall arrangement of an image processing system according to a first embodiment of the present invention.

Referring to FIG. 1, the image processing system is comprised of a MFP (Multi Function Printer) 101, an expansion unit 102 (data processing apparatus) for the MFP, a FTP (File Transfer Protocol) server 103, client computers 104a, 104b, and 104c, and a network 108.

The MFP 101 is an image processing apparatus which is provided with an image reading function, a printing function, a copy function, and the like, and furthermore it is provided with the function of transmitting image data which has been obtained by reading a document or other materials to various types of apparatus, such as the FTP server 103 which is connected to the network 108.

The MFP expansion unit 102 is connected to the MFP 101, and is used to extend the functions of the MFP 101; normally, it is used as a PDL (Page Description Language) for controller. When a PDL job is submitted to the MFP expansion unit 102, appropriate rasterizing is performed, and image data which is generated thereby is transferred to the MFP 101, thereby completing a print sequence.

It should be noted that an integral assembly of the MFP 101 and the MFP expansion unit 102 to be used as an integral image processing apparatus may be integrated in the image processing system.

The MFP expansion unit 102 is provided with a control command transmission function for extending the user interface function of the MFP 101, and transmitting control commands 107a and 107b for performing a file access limitation process for image data which is stored on the FTP server 103.

The FTP server 103 is connected to the MFP 101 via the MFP expansion unit 102 which is connected to the network 108, and is capable of storing image data of documents and the like which have been read by the MFP 101.

The client computers 104a, 104b, and 104c which are connected to the network 108 are able to access the FTP server 103. Furthermore, these client computers 104a, 104b, and 104c are able to submit respective print jobs to the MFP 101 and the MFP expansion unit .102.

The MFP 101 includes a user interface 105 and a box 106. The user interface 105 is an operating section which is comprised of a display device such as a LCD (Liquid Crystal Display), and various commands may be inputted via the user interface 105, as desired by the user. The box 106 is a document storage device implemented by a hard disk or the like, and is able to store image data of documents which have been read or image data or the like which has been received from the network 108.

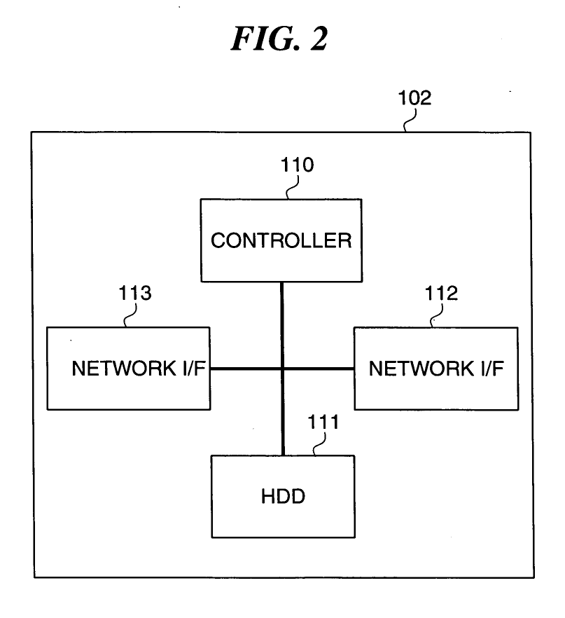

FIG. 2 is a block diagram schematically showing the hardware configuration of an expansion unit 102 for the MFP in FIG. 1.

In FIG. 2, a controller 110 controls the overall operation of the MFP expansion unit 102. A network interface 112 is used to perform communication with the MFP 101. A network interface 113 is used to perform communication with various devices and apparatuses which are connected to the network 108 (for example, the client computers 104a and so on). A HDD (hard disk drive) 111 is able to store programs for controlling the overall operation of the MFP expansion unit 102 and various set values, encryption keys, operation history information, image data, and the like.

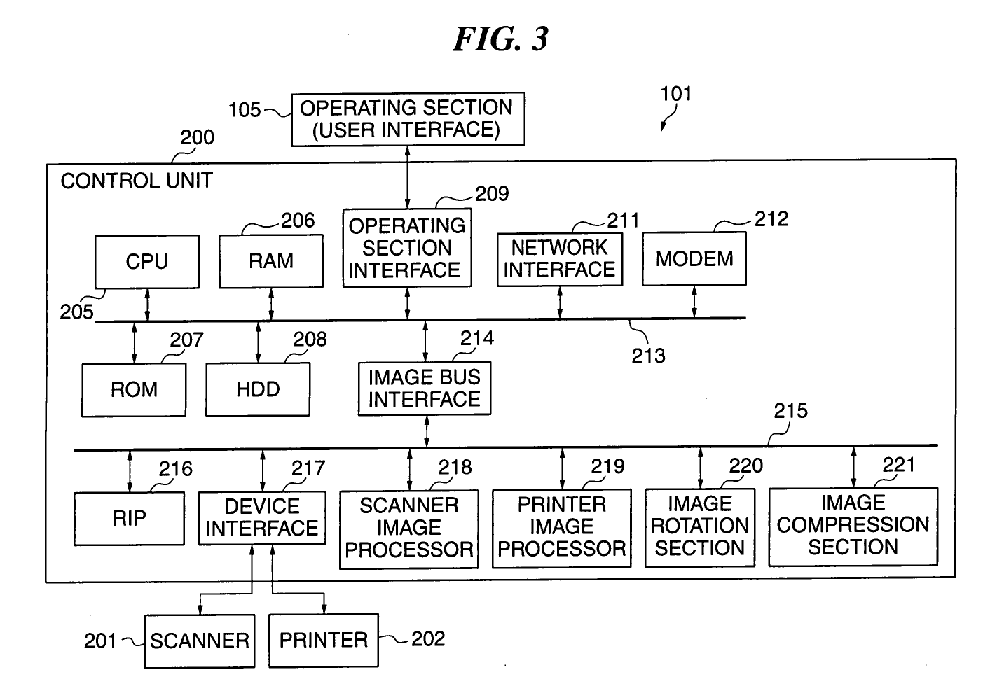

FIG. 3 is a block diagram schematically showing the hardware configuration of the MFP 101 in FIG. 1.

In FIG. 3, a control unit 200 is connected to a scanner 201, which serves as an image input device that reads and inputs images of documents and the like, and to a printer 202 as an image output device, and can be connected to a LAN or a public network (WAN), not shown, to perform input and output of image information and device information.

A CPU 205 controls the entire system within the MFP 101. A RAM 206 is a system work memory for the operation of the CPU 205, and also serves as an image memory which temporarily stores image data. A ROM 207 is a boot ROM, and stores a boot program for the system of the MFP 101.

A HDD 208 stores system software and image data. An operating section interface 209 provides interface with the operating section (UI) 105, and outputs image data which is to be displayed on the UI 105 to the UI 105. Furthermore, the operating section interface 209 is provided with the function of transferring to the CPU 205 information which the user of the MFP 101 has inputted via the UI 105.

A network interface 211 is connected to a LAN, not shown, and performs input and output of information. A modem 212 is connected to a public network, not shown, and also performs input and output of information. All the various devices described above are connected together via a system bus 213.

An image bus interface 214 is a bus bridge which converts data structure, and is connected to the system bus 213 and an image bus 215 which transfers image data at high speed. This image bus 215 may be a PCI bus or an IEEE1394 interface. To this image bus 215 there are connected a raster image processor (RIP) 216, a device interface 217, a scanner image processor 218, a printer image processor 219, an image rotation section 220, and an image compression section 221.

The RIP 216 expands PDL code into bitmap images. This function may also be implemented in the MFP expansion unit 102, described above. The device interface 217 connects the scanner 201 and the printer 202 with the control unit 200.

The scanner image processor 218 performs correction, processing, and editing on the image data which has been inputted by the scanner 201. The printer image processor 219 performs print correction, resolution conversion, and the like on the image data for output to the printer 202. The image rotation section 220 performs rotation of the image data. And the image compression section 221 converts multi-valued image data into JPEG (Joint Photographic Experts Group) format, and performs JBIG (Joint Bi-level Image Expert Working Group), MMR (Modified Modified Read), or MH (Modified Huffman) compression and expansion processing on binary image data.

Next, a processing operation will be described which is executed by the image processing system of FIG. 1 when transmitting image data of a document which has been read by the MFP 101 to the FTP server 103 for storage therein.

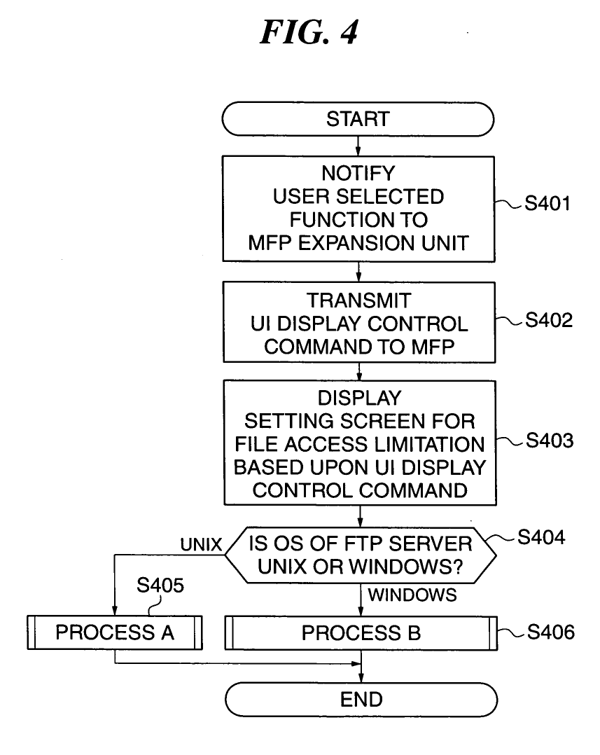

FIG. 4 is a flow chart showing an access limitation process for image data, which is executed by the image processing system of FIG. 1.

In FIG. 4, when a scanned document transmission function button on the UI 105, not shown, is pressed by the user, the MFP 101 issues a notification to the effect that a scanned document transmission function has been selected, to the MFP expansion unit 102 (step S401). This scanned document transmission function automatically transmits image data of a document which has been read by the scanner 201 to the FTP server 103 or the like on the network 108 for storage therein.

Upon receipt of this notification from the MFP 101, the MFP expansion unit 102 transmits to the MFP 101 (step S402) a user interface display control command 107a in order to cause a predetermined display screen to be displayed on the UI 105 of the MFP 101.

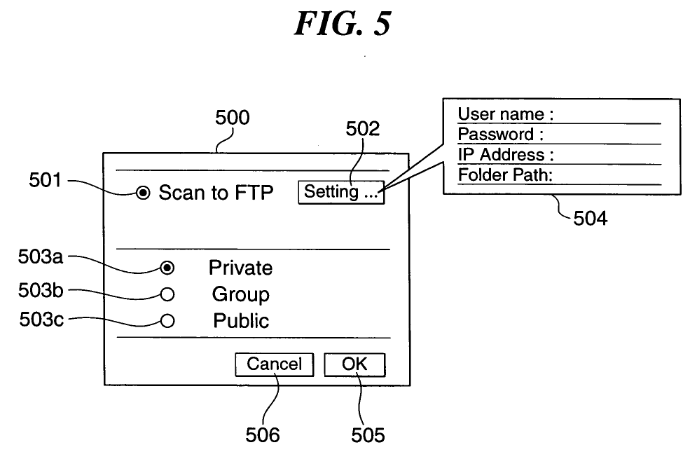

Next, upon receipt of the user interface display control command 107a by the MFP 101, the setting screen 500 shown in FIG. 5 for file access limitation is displayed on the UI 105 (step S403). On this setting screen 500, it is possible to set the destination for transmission of the image data of a document or the like which has been read by the MFP 101, and to set an access limitation for this image data which has been stored on the transmission destination.

FIG. 5 is a diagram showing an example of a screen which is displayed on the operating section 105 during execution of the process of FIG. 4.

Referring to FIG. 5, a radio box 501 on the setting screen 500 is for setting the destination for transmission of the image data to the FTP server 103. A button 502 is for calling up a screen 504 for inputting items to be set in relation to the destination for transmission of the image data.

The screen 504 includes fields for inputting a user name and password for logging in to the FTP server 103, and for inputting an IP address of the FTP server 103 and a path for a folder for storing the image data.

Radio boxes 503a, 503b, and 503c are for the user to select and designate the desired type of file access limitation for the image data which is stored, for example, on the FTP server 103. Here, as the type of file access limitation, it is possible to designate the level of file access limitation.

An OK button 505 is a button for confirming the contents which have been set on the setting screen 500, and a cancel button 506 is a button for invalidating (canceling) the contents which have been set on the setting screen 500.

Returning to FIG. 4, when the OK button 505 is pressed after one of the radio boxes 503a through 503c in FIG. 5 has been selected by the user and all inputs on the screen 500 are completed, the MFP expansion unit 102 accesses the FTP server 103 which is the destination for transmission of the image data, and makes a decision determination (step S404) as to whether the OS (Operating System) which is being used by the FTP server 103 is a Unix type OS or a Windows type OS (step S404). When the result of this determination is that the OS is a Unix type OS which is provided with the function of being able to impose access limitation on a file-by-file basis, then the flow of control process proceeds to a process A (step S405); while, when the OS is a Windows type OS in which it is not possible to impose access limitation on a file-by-file basis, then the process proceeds to a process B (step S406).

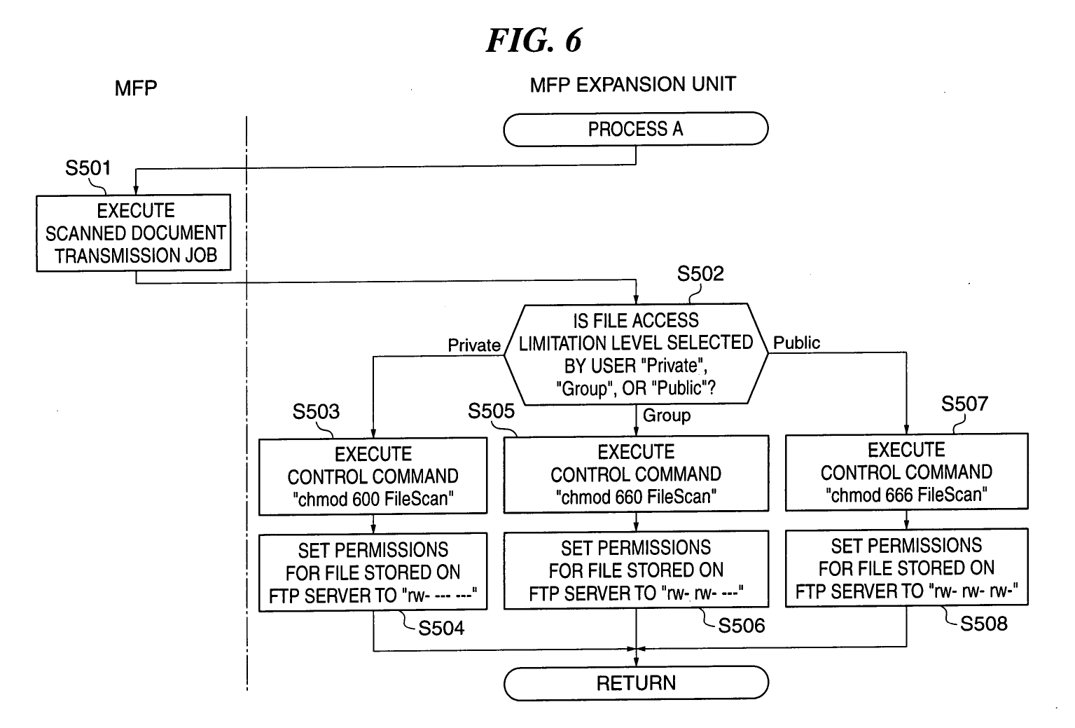

FIG. 6 is a flow chart showing the process A which is executed in the step S405 in FIG. 4.

In FIG. 6, when the MFP expansion unit 102 checks the OS which is being used by the FTP server 103 and notifies the MFP 101 that a Unix type OS is being used, the MFP 101 executes a scanned document transmission job (step S501). In this job, the image data of a document which has been read by the scanner 201 and which has been subjected to appropriate processing by the scanner image processor 218 and so on is transmitted from the MFP 101 to the FTP server 103 via the MFP expansion unit 102 and the network 108, and is stored on the HDD 208 FTP server 103.

Next, when the transmission of the image data from the MFP 101 to the FTP server 103 has been completed, the following operation is performed by the MFP expansion unit 102, according to the access limitation level which has been set by the user on the setting screen 500 (the step S502). That is, if the radio box 503a was selected on the setting screen 500, in other words, if “Private” has been selected, in order to set an access limitation for the image data has been set by the MFP expansion unit 102 to the effect that only the user himself is allowed to read the image data, the MFP expansion unit 102 accesses the image data stored in the FTP server 103 and transmits a “chmod 600 FileName” as the control command 107b (step. S503) in order to access the image data which is stored in the FTP server 103, and in order to set for setting one of permissions prescribed by the Unix type OS (three types of permission for read, write, and execute, are set for the owner of the file, the group users, and other users, respectively) (step S503). By doing this, the permissions for the image data which is stored in the FTP server 103 is set to “rw- --- ---”, and hence the access limitation for this image data is set to the effect that only the user himself can perform read and write operations on the image data (step S504). Thus, with the control command, it is possible to designate the one or more subjects who are permitted to perform each of reading, writing, and execution of the data.

On the other hand, if the result of the determination in the step S502 is that the radio box 503b was selected on the setting screen 500, in other words, if “Group” has been selected, then, since in order to set an access limitation has been set for the image data by the MFP expansion unit 102 to the effect that, in addition to the user himself, persons who belong to a predetermined group, e.g., a group to which the user belongs, are allowed to read the image data, the MFP expansion unit 102 accesses the image data stored in the FTP server 103 and transmits a “chmod 660 FileName” as the control command 107b is transmitted (step S505) in order to access the image data which is stored in the FTP server 103, and in order to set corresponding for setting another one of the permissions prescribed by the Unix type OS (step S505). By doing this, the permissions for the image data which is stored in the FTP server 103 is set to “rw- rw- ---”, and hence the access limitations for this image data is set to the effect that the user himself, and also persons belonging to his group, can perform read and write operations (step S506).

Finally, if the result of the determination in the step S502 is that the radio box 503c was selected on the setting screen 500, in other words, if “Public” has been selected, then, since in order to set an access limitation has been set for the image data by the MFP expansion unit 102 to the effect that anybody is allowed to read the image data, the MFP expansion unit 102 accesses the image data stored in the FTP server 103 and transmits a “chmod 666 FileName” as the control command 107b is transmitted (step S507) in order to access the image data which is stored in the FTP server 103, and in order to set corresponding for setting the last one of the permissions prescribed by the Unix type OS (step S507). By doing this, the permissions for the image data which is stored in the FTP server 103 is set to “rw- rw- rw-”, and hence the access limitations for this image data is set to the effect that anybody can perform read and write operations (step S508).

Here, it will be acceptable, when the image data which is stored on the FTP server 103 is to be allowed to be read by anybody, it may be arranged such that the MFP expansion unit 102 sets the control command 107b transmitted to the FTP server 103 to “chmod 644 FileName”, to thereby set the permissions for the image data to “rw- r-- --” so as not to give any write authority to anyone other than the owner of the file. Or, it would also be acceptable to add a new radio button may be added on the setting screen 500 for initiating this operation.

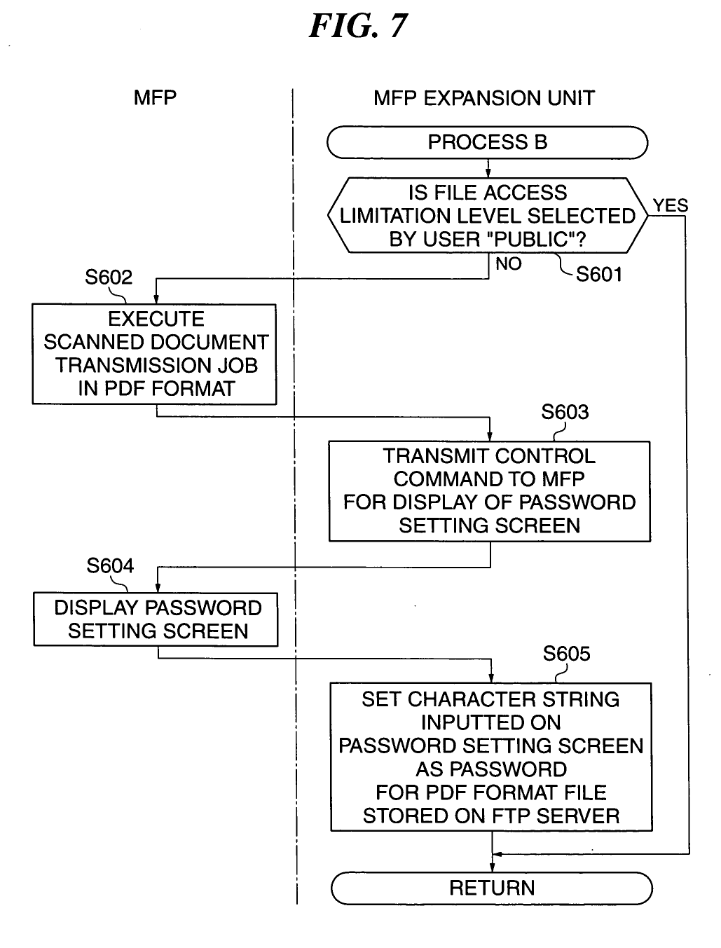

FIG. 7 is a flow chart showing the process B which is executed in the step S406 in FIG. 4.

In this process, it is assumed that the image data is stored on the FTP server 103 running on an OS which is incapable of implementing access limitation for individual files on a file-by-file basis. In this case, an access limitation function for the folder in which the image data are stored and a file password function for application software which is installed upon the FTP server 103 are used is employed in order to provide an access limitation function for the folder in which the image data are stored. Here, the application software is application software for the so-called PDF format (Portable Document Format).

Conventionally, to create image data, it has been possible for the user can select desired one from among a plurality of file formats such as JPEG, TIFF, and the PDF format and the like, but in the present embodiment, by fixing this to only PDF is used to utilize the password function which is incorporated in the PDF format. However, this is done only if “Private” or “Group” has been selected on the setting screen 500; if “Public” has been selected, the password function is not used.

In FIG. 7, the MFP expansion unit 102 determines whether or not the level of access limitation which has been set on the setting screen 500 by the user is “Public”, and if it is not “Public”, in other words, if it is “Private” or “Group”, then the MFP expansion unit 102 notifies the MFP 101 that “Private” or “Group” has been selected (step S601).

Next, upon receipt of the above notification from the MFP expansion unit 102, the MFP 101 executes a scanned document transmission job in the PDF format (step S602). In this job, the image data of the document which has been read by the scanner 201 and subjected to appropriate processing by the scanner image processor 218 and so on is transmitted from the MFP 101 to the FTP server 103 via the MFP expansion unit 102 and the network 108, for storage therein.

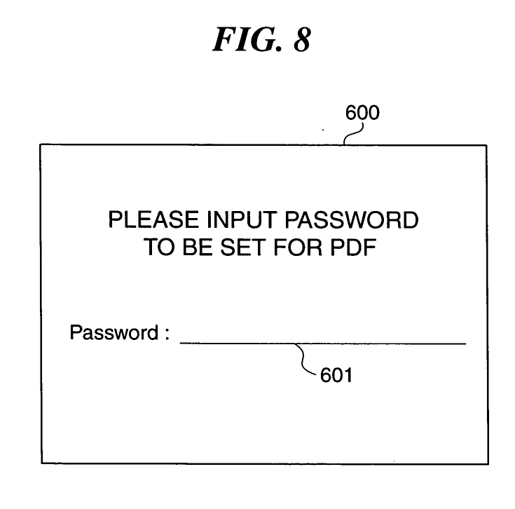

Next, the MFP expansion unit 102 transmits a user interface display control command 107a to the UI 105 of the MFP 101 to cause a password setting screen 600 shown in FIG. 8 to be displayed (step S603).

Upon receipt of the user interface display control command 107a, the MFP 101 displays the password setting screen 600 on the UI 105 (step S604). Next, when the user inputs a desired character string to a character string field 601, the MFP expansion unit 102 sets the inputted character string as the password for the image data in PDF format which is stored on the FTP server 103 (step S605).

On the other hand, if the result of the determination in the step S601 is that “Public” has been selected, then the process is immediately terminated and returned to the process of FIG. 4.

According to the first embodiment described above, the MFP expansion unit 102 which is connected to the MFP 101 imposes an access limitation upon document image data (electronic document) which has been read by the MFP 101, transmitted over the network 108 to the FTP server 103 and stored therein, according to an input operation on the screen displayed on the UI 105 of the MFP 101. Therefore, it becomes unnecessary for the user to separately access the FTP server 103 to impose a direct access limitation upon the image data which is stored therein. As a result, it is possible to alleviate the burden upon the user.

Furthermore, even if the FTP server 103 is running on an OS which has no access limitation function on a file-by-file basis and the image data is stored therein, it is possible to impose an access limitation upon the image data by using the application software on the FTP server 103, and therefore, it becomes possible to alleviate the load upon the user. Moreover, even if a confidential document has been read, it becomes possible even more to enhance the security of this confidential document which has been converted into electronic form.

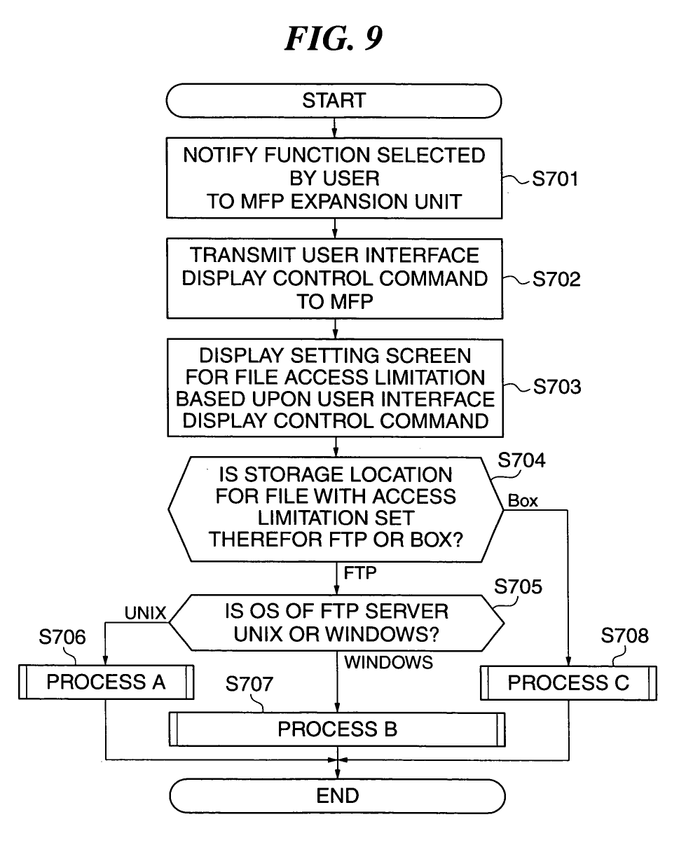

FIG. 9 is a flow chart showing an image data access limitation process which is executed by an image processing system according to a second embodiment of the present invention.

The second embodiment has a basic construction identical with that shown in FIGS. 1 through 3 for the first embodiment, and description thereof is therefore omitted. In the following, only those which the second embodiment differ from the first embodiment described above will be described.

In the process of the FIG. 9 flow chart, steps S706 and S707 are the same as the steps S405 and S406 of the flow chart showing the first embodiment shown in FIG. 4, and description thereof is therefore omitted.

In FIG. 9, when a scanned document transmission function button, not shown, upon the UI 105 is pressed by the user, the MFP 101 issues a notification to the effect that the scanned document transmission function has been selected, to the MFP expansion unit 102 (step S701).

Upon receipt of the notification from the MFP 101, the MFP expansion unit 102 transmits to the MFP 101 a user interface display control command 107a to cause a predetermined display screen to be displayed on the UI 105 of the MFP 101 (step S702).

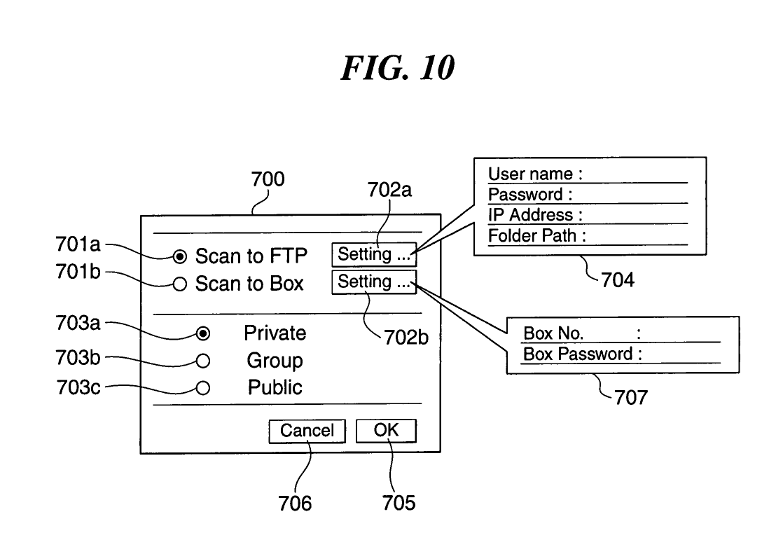

Next, upon receipt of the user interface display control command 107a by the MFP 101, a file access limitation setting screen 700 shown in FIG. 10 is displayed on the UI 105 (step S703). On this setting screen 700, it is possible to set the destination for transmission of the image data of a document or the like which has been read by the MFP 101, and to set an access limitation for this image data which has been stored on the transmission destination.

Referring to FIG. 10, radio boxes 701a and 701b on the setting screen 700 are, respectively, for setting the destination for transmission of the image data to the FTP server 103, or to the box 106 provided in the MFP 101. Buttons 702a and 702b are for calling up screens 704 and 707 for inputting items to be set in relation to the destination for transmission of the image data. The “box” means a storage (region) in which a plurality of items of data are collectively stored. The user can impart a name or a number to his “box”, for classification of the data.

The screen 704 has fields for inputting the user name and the password of the user for logging in to the FTP server 103, the IP address of the FTP server 103, and the path of the folder in which the image data are stored. The screen 707 has a field for inputting a box number for accessing the box 106, and a field for inputting a box password, if a password has been set for the box 106.

Radio boxes 703a, 703b, and 703c are for the user to select and designate a desired type of file access limitation for image data which is stored, for example, on the FTP server 103. An OK button 705 is for confirming the contents which have been set on the setting screen 700, and a cancel button 706 is for invalidating (canceling) the contents which have been set on the setting screen 700.

Referring again to FIG. 9, when the OK button 705 is pressed after one of the radio boxes 703a through 703c in FIG. 10 has been selected by the user and all inputs on the screen 700 are completed, the MFP expansion unit 102 makes a determination as to whether or not the storage location for the image data file for which access limitation has been set on the setting screen 700 is the FTP server 103 or the box 106 within the MFP 101 (step S704). When the result of this determination is that the FTP server 103 has been selected as the storage location for the image data, that is, “Scan to FTP” has been selected on the setting screen 700, then the process proceeds to a step S705, while, when the result of this determination is that the box 106 has been selected as the storage location for the image data, that is, “Scan to Box” has been selected on the setting screen 700, then the process proceeds to a process C in a step S708, described hereinafter.

In the step S705, the MFP expansion unit 102 accesses the FTP server 103 which is the destination for transmission of the image data, and makes a determination as to whether the OS which is being used by the FTP server 103 is a Unix type OS or a Windows type OS.

When the result of the determination in the step S705 is that the OS is an OS like Unix which is provided with the function of being able to impose access limitation on a file-by-file basis, then the process proceeds to the above described process A in FIG. 6 (step S706), while, when the OS is an OS type Windows in which it is not possible to impose access limitation on a file-by-file basis, then the process proceeds to the above described process B in FIG. 7 (step S707).

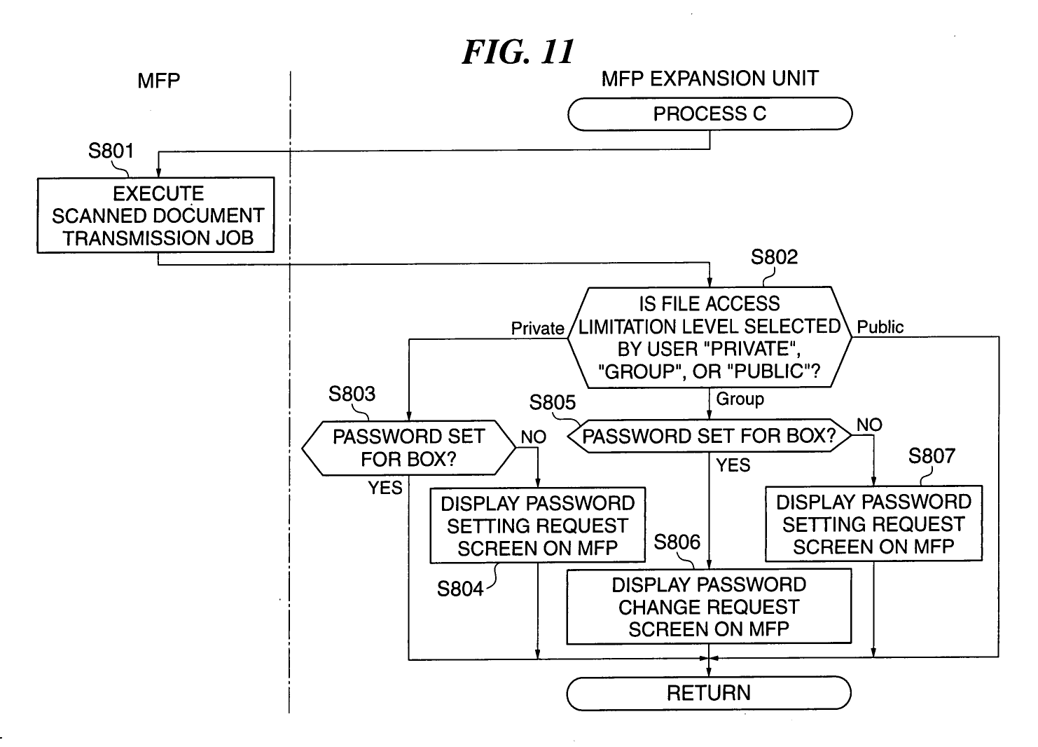

FIG. 11 is a flow chart showing the process C which is executed in the step S708 in FIG. 9.

In FIG. 11, first, the MFP 101 executes a scanned document box transmission job (step S801). In this job, the image data of a document which has been read by the scanner 201 and subjected to appropriate processing by the scanner image processor 218 and so on is transmitted from the MFP 101 to the box 106 in the MFP 101, and is stored therein.

Next, the MFP expansion unit 102 performs the following operation according to the access limitation level which has been set by the user on the setting screen 700 (step S802). If the radio box 703a has been selected on the setting screen 700, in other words, if “Private” has been selected, then the MFP expansion unit 102 accesses the box 106 which is the destination for transmission for the image data, and makes a determination as to whether or not a password is set for the box 106, in other words, as to whether or not the box 106 is locked (step S803).

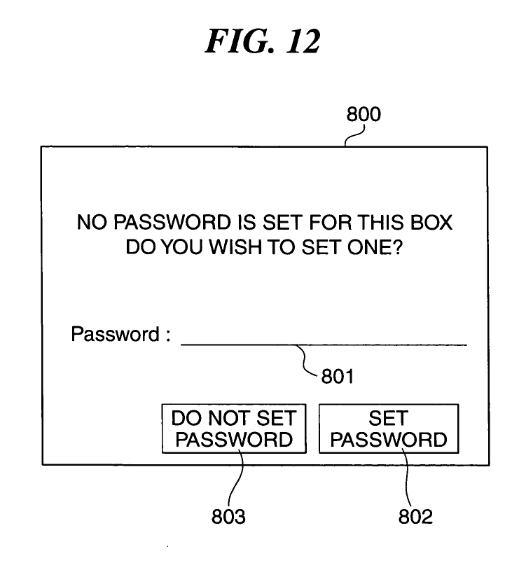

When the result of the determination in the step S803 is that the box 106 is not locked due to setting of a password, then a password setting request screen 800 shown in FIG. 12 is displayed on the UI 105 of the MFP 101, and the user is prompted to set a password (step S804). To set a password on the request screen 800, the user inputs his desired password in a password input field 801, and presses a button 802. On the other hand, if he does not wish to set any password for the box 106, then he omits password entry and merely presses a button 803.

If the result of the determination in the step S803 is that the box 106 has been locked due to setting of a password, then the process is immediately terminated. This processing is for prompting the user to set a password when he has set “Private” on the setting screen 700, of inviting the user to set a password and no password has been set for the box 106.

If the result of the determination in the step S802 is that the radio box 703b has been selected on the setting screen 700, that is, “Group” has been selected, then the MFP expansion unit 102 accesses the box 106 which is the destination for transmission of the image data, and makes a determination as to whether or not a password has been set so that the box 106 is locked (step S805). If the result of this determination is that the box is not locked due to no password being set, then the password setting request screen 800 is displayed on the UI 105 of the MFP 101, and the user is prompted to set a password (step S806). To set a password on the request screen 800, the user inputs his desired password in the password input field 801, and presses the button 802. On the other hand, if he does not desire to set any password for the box 106, then he omits password entry and merely presses the button 803.

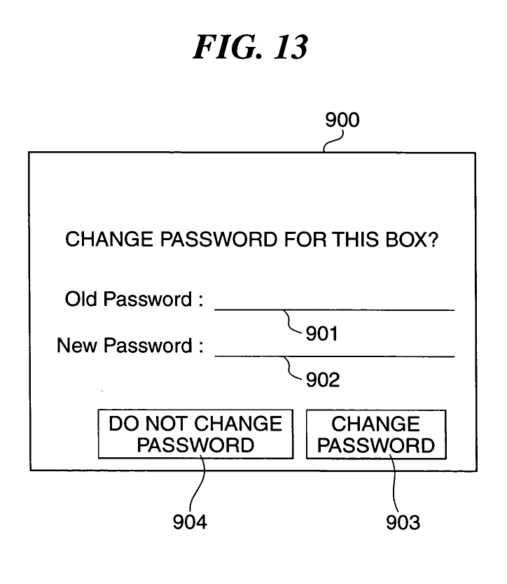

On the other hand, if the result of the determination in the step S805 is that the box 106 is indeed locked due to a password being set, then a password change request screen 900 shown in FIG. 13 is displayed on the UI 105 of the MFP 101, and the user is prompted to change his password for the box 106 (step S806) . To perform password change on the request screen 900, the user inputs his previous password in a password input field 901, and inputs his desired new password in a password input field 902 and presses a button 903. On the other hand, if the user does not desire to rewrite his password, then he presses a button 904. This processing is for prompting the user to set a password when “Group” has been set on the setting screen 700 and no password has been set for the box 106. Furthermore, the above processing is for prompting the user to change his password in the case where a password is already set for the box 106, but due to “Group” being selected, it is necessary to set a password that can be also used by other members belonging to the group.

If the result of the determination in the step S802 is that the radio box 703c has been selected on the setting screen 700, in other words, “Public” has been selected, and then the MFP expansion unit 102 immediately terminates the present process.

According to the second embodiment described above, the MFP expansion unit 102 which is connected to the MFP 101 imposes an access limitation upon document image data (electronic document) which has been read by the MFP 101 and stored in the box 106, according to an input operation on the screen displayed on the UI 105 of the MFP 101. Therefore, it is possible for the user to impose a direct access limitation by using a password set for the box 106 even when a box transmission job having no function of imposing access limitation on a file-by-file basis is performed, and thus it is possible to alleviate the burden upon the user. Moreover, even if a confidential document has been read, it becomes possible even more to enhance the security of this confidential document which has been converted into electronic form.

Furthermore, even if the FTP server 103 is running on an OS which has no access limitation function on a file-by-file basis and the image data is stored therein, it is possible to impose an access limitation upon the image data by using the application software on the FTP server 103, and therefore, it becomes possible to alleviate the load upon the user.

Although in the above described first and second embodiments, the MFP 101 and the MFP expansion unit 102 are provided as separate units, they may be integrated together.

It is to be understood that the object of the present invention may also be accomplished by supplying a system or an apparatus with a storage medium in which a program code of software which realizes the functions of the above described embodiment is stored, and causing a computer (or CPU or MPU) of the system or apparatus to read out and execute the program code stored in the storage medium.

In this case, the program code itself read from the storage medium realizes the functions of any of the embodiments described above, and hence the storage medium in which the program code is stored constitutes the present invention.

Examples of the storage medium for supplying the program code include a floppy (registered trademark) disk, a hard disk, an optical disk, a magnetic-optical disk, a CD-ROM, a CD-R, a CD-RW, DVD-ROM, a DVD-RAM, a DVD-RW, a DVD+RW, a magnetic tape, a nonvolatile memory card, and a ROM. Alternatively, the program may be downloaded via a network.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

1. A data processing apparatus which is capable of storing image data of a document in one of a plurality of storage devices for which respective methods for restricting access to stored data are different, comprising:
a display device that displays a screen for designating a type of access limitation for the image data; and
a setting device that sets an access limitation for the image data corresponding to the type of access limitation designated with the screen, according to the method for the storage device which stores the image data.

2. A data processing apparatus as described in claim 1, wherein said setting device performs at least one process selected from the group consisting of transmitting a command which designates a subject who is permitted to perform at least one of reading and writing the image data, setting a password for the image data, and setting a password to a region in which the image data is stored, according to the method for the storage device which stores the image data.

3. A data processing apparatus as described in claim 1, wherein said setting device performs at least one process selected from the group consisting of changing a subject who is permitted to perform at least one of reading and writing the image data, selecting whether a password is to be set or not for the image data, selecting whether a password is to be set or not for the region in which the image data is stored, and changing the password set for the region, according to the type of access limitation designated with the screen.

4. A data processing apparatus as described in claim 1, wherein said display device displays at least one of a screen for designating the type of access limitation for the image data, a screen for designating one of the storage devices on which the image data is to be stored, and a screen for designating a password.

5. An image processing system comprising an image processing apparatus having a display section, a data processing apparatus connected to said image processing apparatus, and a server connected to said data processing apparatus, the image processing system being capable of storing image data of a document which has been read in said server,
wherein said data processing apparatus comprises:
a control command output device that outputs a control command for causing a predetermined screen to be displayed on said display section of said image processing apparatus; and
an access limitation setting device that sets an access limitation for image data which is stored in said server, according to a type of access limitation which has been selected on the predetermined screen caused to be displayed by the control command.

6. An image processing system as described in claim 5, wherein said access limitation setting device is operable when said server is running on an operating system which is capable of setting access limitation for the image data on a file-by-file basis, to set access limitation by using a function of the operating system, and operable when said server is running on an operating system which is not capable of setting access limitation for the image data on a file-by-file basis, to set access limitation by using a password setting function provided by said server.

7. An image processing system comprising an image processing apparatus having a display section and being capable of storing image data of a document which has been read, and a data processing apparatus connected to said image processing apparatus,
wherein said data processing apparatus comprises:
a control command output device that outputs a control command for causing a predetermined screen to be displayed on said display section of said image processing apparatus; and
an access limitation setting device that sets an access limitation for image data which is stored in said image processing apparatus, according to a type of access limitation which has been selected on the predetermined screen caused to be displayed by the control command.

8. An image processing system as described in claim 7, wherein said image processing apparatus has a storage region in which the image data is stored, and said access limitation setting device is operable when no password is set for the storage region, to set a password for the storage region, and operable when a password is set for the storage region, to change the password which is set for the storage region.

9. An access limitation setting method for a data processing apparatus which is capable of storing image data of a document in one of a plurality of storage devices for which respective methods for restricting access to stored data are different, comprising:
a display step of displaying a screen for designating a type of access limitation for the image data; and
a setting step of setting an access limitation for the image data corresponding to the type of access limitation designated with screen, according to the method for the storage device which stores the image data.

10. An access limitation setting method as described in claim 9, wherein said setting step comprises performing at least one process selected from the group consisting of transmitting a command which designates a subject who is permitted to perform at least one of reading and writing the image data, setting a password for the image data, and setting a password to an region in which the image data is stored, according to the method for the storage device which stores the image data.

11. An access limitation setting method as described in claim 9, wherein said setting step comprises performing at least one process selected from the group consisting of changing a subject who is permitted to perform at least one of reading and writing the image data, selecting whether a password is to be set or not for the image data, selecting whether a password is to be set or not for the region in which the image data is stored, and changing the password set for the region, according to the type of access limitation designated with the screen.

12. An access limitation setting method as described in claim 9, wherein said display step comprises displaying at least one of a screen for designating the type of access limitation for the image data, a screen for designating one of the storage devices on which the image data is to be stored, and a screen for designating a password.

13. A control method for an image processing system comprising an image processing apparatus having a display section, a function expansion apparatus connected to the image processing apparatus, and a server connected to the data processing apparatus, the image processing system being capable of storing image data of a document which has been read in the server, comprising:
a control command output step of outputting a control command for causing a predetermined screen to be displayed on the display section of the image processing apparatus, to the server; and
an access limitation setting step of setting an access limitation for image data which is stored in the server, according to a type of access limitation which has been selected on the predetermined screen caused to be displayed by the control command.

14. A control method for an image processing system comprising an image processing apparatus having a display section and being capable of storing image data of a document which has been read, and a data processing apparatus connected to the image processing apparatus, comprising:
a control command output step of causing the data processing apparatus to output a control command for causing a predetermined screen to be displayed on the display section of the image processing apparatus, to the image processing apparatus; and
an access limitation setting step of setting an access limitation for image data which is stored in said image processing apparatus, according to a type of access limitation which has been selected on the predetermined screen caused to be displayed by the control command.
